(19) United States
(12) Patent Application Publication
(10) Pub. No.: US 2014/0300612 A1
(43) Pub. Date: Oct. 9, 2014

(54) METHODS FOR AVATAR CONFIGURATION AND REALIZATION, CLIENT TERMINAL, SERVER, AND SYSTEM

(71) Applicant: TENCENT TECHNOLOGY (SHENZHEN) COMPANY LIMITED, Shenzhen (CN)

(72) Inventors: Keyou Li, Shenzhen (CN); Yanbin Tang, Shenzhen (CN); Jing Shen, Shenzhen (CN); Min Huang, Shenzhen (CN); Hao Zhan, Shenzhen (CN)

(73) Assignee: TENCENT TECHNOLOGY (SHENZHEN) COMPANY LIMITED, Shenzhen (CN)

(21) Appl. No.: 14/289,924

(22) Filed: May 29, 2014

Related U.S. Application Data
(63) Continuation of application No. PCT/CN2014/073759, filed on Mar. 20, 2014.

(30) Foreign Application Priority Data
Apr. 3, 2013 (CN) 201310113497.3

(51) Int. Cl. G06T 13/40

(52) U.S. Cl. CPC G06T 13/40
USPC 345/473

(57) ABSTRACT

It is provided a method for avatar configuration, a method for avatar realization, a client terminal, a server, and a system for avatar management. The method for avatar configuration may include: outputting, at a client terminal, an avatar model for the user to configure when the client terminal receives a request from the user to configure an avatar; obtaining, at the client terminal, configuration data of the avatar model, the configuration data comprising bone movement data and decoration data; and performing, at the client terminal, an encoding process on the configuration data, and forming avatar data of the user. The way of configuring an avatar can be extended, and the avatar can be customized. Therefore, the representation of the avatar can meet actual requirements of the user to exactly represent the image that the user wants to show.

### CROSS REFERENCE TO RELATED APPLICATIONS

This application is a U.S. continuation application under 35 U.S.C. §111(a) claiming priority under 35 U.S.C. §§120 and 365(c) to International Application No. PCT/CN2014/073759 filed Mar. 20, 2014, which claims the priority benefit of Chinese Patent Application No. 201310113497.3 filed Apr. 3, 2013, the contents of which are incorporated by reference herein in their entirety for all intended purposes.

### FIELD

The present disclosure relates to network systems, particularly to the technical field of computer graphic processing, and more particularly, to a method for avatar configuration, a method for avatar realization, a client terminal, a server, and a system.

### BACKGROUND

This section provides background information related to the present disclosure which is not necessarily prior art.

An avatar of a user refers to a virtual image of the user in the internet or an internet application, for example, a character that the user plays in a game application, a virtual image of the user in an instant messaging application, a virtual image of the user in an SNS (Social Networking Service) application, etc. Nowadays, avatars are configured and realized in the way of two-dimensional pictures. Taking a personal avatar in an instant messaging application for an example, a user may select a character image as his/her avatar to represent himself/herself; or, the instant messaging system may provide functionality to upload photos, enabling the user to upload favorite photos, and the system may provide simple image editing functions, such as cropping, scaling, translation, rotation, etc, which enables the user to edit the photos to form an image of his/her avatar. However, in the above art, an avatar is only some contents of a picture, and the user cannot adjust the posture or movement of the avatar or adjust any local decorations. Therefore, the way of configuring the avatar is too simply, and it is unable to realize customization, which results in that the representation of the avatar is unable to meet the user's actual requirements to exactly represent a personal image that the user actually wants to show.

### SUMMARY

According to various embodiments of the invention, it is provided a method for avatar configuration, a method for avatar realization, a client terminal, a server, and a system, in which the way of configuring an avatar can be extended, and the avatar can be customized. Therefore, the representation of avatar can meet actual requirements of a user, and the avatar can exactly represent an image that the user wants to show.

According to some embodiments of the invention, it is provided a method for avatar configuration, comprising: outputting, at a client terminal, an avatar model for the user to configure when the client terminal receives a request from the user to configure an avatar; obtaining, at the client terminal, configuration data of the avatar model, the configuration data comprising bone movement data and decoration data; and performing, at the client terminal, an encoding process on the configuration data, and forming avatar data of the user.

According to some embodiments of the invention, it is provided a method for avatar realization, comprising: extracting, at a client terminal, identification information of a user from an pulling request when the client terminal detects the pulling request for an avatar of the user; obtaining, at the client terminal, avatar data of the user according to the identification information of the user, wherein the avatar data is formed by encoding configuration data of an avatar model, and the configuration data comprises bone movement data and decoration data; and analyzing, at the client terminal, the avatar data of the user, and calling the avatar model to represent the avatar of the user.

According to some embodiments of the invention, it is provided a method for avatar realization, comprising: extracting, at a server, identification information of a user from an obtaining request when the server receives the obtaining request for avatar data, wherein the obtaining request is sent by a client terminal; searching, at the server, for the avatar data of the user stored in association with the identification information of the user according to the identification information of the user, wherein the avatar data is formed by encoding configuration data of an avatar model, and the configuration data comprises bone movement data and decoration data; and detecting, at the server, a performance parameter of the client terminal, and returning the avatar data of the user to the client terminal according to the performance parameter of the client terminal.

According to some embodiments of the invention, it is provided a client terminal, comprising: a configuration module, which is configured to output an avatar model for the user to configure when receiving a request from the user to configure an avatar; an obtaining module, which is configured to obtain configuration data of the avatar model, the configuration data comprising bone movement data and decoration data; and an encoding module, which is configured to perform an encoding process on the configuration data, and form avatar data of the user.

According to some embodiments of the invention, it is provided a client terminal, comprising: an identification extracting module, which is configured to extract identification information of a user from an pulling request when detecting the pulling request for an avatar of the user; an obtaining module, which is configured to obtain avatar data of the user according to the identification information of the user, wherein the avatar data is formed by encoding configuration data of an avatar model, and the configuration data comprises bone movement data and decoration data; and a representing module, which is configured to analyze the avatar data of the user and call the avatar model to represent the avatar of the user.

According to some embodiments of the invention, it is provided a server, comprising: an identification extracting module, which is configured to extract identification information of a user from an obtaining request when receiving the obtaining request for avatar data, wherein the obtaining request is sent by a client terminal; a searching module, which is configured to search for the avatar data of the user stored in association with the identification information of the user according to the identification information of the user, wherein the avatar data is formed by encoding configuration data of an avatar model, and the configuration data comprises bone movement data and decoration data; and a data processing module, which is configured to detect a performance parameter of the client terminal and return the avatar data of the user to the client terminal according to the performance parameter of the client terminal.

According to some embodiments of the invention, it is provided a system for avatar management, comprising a server as provided in the sixth aspect of the invention, and a client terminal as provided in the fourth aspect of the invention and/or a client terminal as provided in the fifth aspect of the invention.

Implementation of exemplary embodiments of the invention can have the following beneficial effects.

In exemplary embodiments of the invention, the client terminal may output an avatar model for a user to configure, obtain configuration data including bone movement data and decoration data, and perform an encoding process on the configuration data to form avatar data of the user. Since the configuration data is generated by being configured by the user, and since bone movements and customized decorations may be added during the configuration, the way of configuring the avatar can be extended, and the avatar can be customized. Thus, the representation of the avatar can meet actual requirements of the user to exactly represent the image that the user wants to show.

### BRIEF DESCRIPTION OF THE DRAWINGS

The accompanying drawings are presented to aid in the description of embodiments of the invention and are provided solely for illustration of the embodiments and not limitation thereof.

FIG. 1 is a flow chart of a method for avatar configuration according to one embodiment of the invention;

FIG. 2 is a flow chart of a method for avatar configuration according to another embodiment of the invention;

FIG. 3a is a structure diagram of a face model according to yet another embodiment of the invention;

FIG. 3b is a structure diagram of a body model according to yet another embodiment of the invention;

FIG. 3c is a structure diagram of a clothing model according to yet another embodiment of the invention;

FIG. 4a is a structure diagram of arrangement layers of an avatar according to yet another embodiment of the invention;

FIG. 4b is an effect diagram of an avatar according to yet another embodiment of the invention;

FIG. 5 is a flow chart of a method for avatar realization according to yet another embodiment of the invention;

FIG. 6 is a flow chart of a method for avatar realization according to yet another embodiment of the invention;

FIG. 7 is a flow chart of a method for avatar realization according to yet another embodiment of the invention;

FIG. 8 is a flow chart of a method for avatar realization according to yet another embodiment of the invention;

FIG. 9 is a structure diagram of a client terminal according to yet another embodiment of the invention;

FIG. 10 is a structure diagram of a client terminal according to yet another embodiment of the invention;

FIG. 11 is a structure diagram of a client terminal according to yet another embodiment of the invention;

FIG. 12 is a structure diagram of a client terminal according to yet another embodiment of the invention;

FIG. 13 is a structure diagram of an obtaining module of a client terminal according to yet another embodiment of the invention;

FIG. 14 is a structure diagram of a server according to yet another embodiment of the invention;

FIG. 15 is a structure diagram of a server according to yet another embodiment of the invention;

FIG. 16 is a structure diagram of a data processing module of a server according to yet another embodiment of the invention.

### DETAILED DESCRIPTION OF ILLUSTRATED EMBODIMENTS

The present invention is hereinafter described further in detail with reference to the accompanying drawings so as to make the objective, technical solution, and merits of exemplary embodiments more apparent. The term “exemplary” used throughout this description means “serving as an example, instance, or illustration,” and should not necessarily be construed as preferred or advantageous over other exemplary embodiments. It would be apparent that a person having ordinary skills in the art may obtain other embodiments based on the illustrated exemplary embodiments of the invention without paying any creative work, and these embodiments should also be within the protection scope sought by the present invention.

In exemplary embodiments of the invention, an avatar of a user refers to a virtual image of the user in the internet or an internet application, for example, a character that the user plays in a game application, a virtual image of the user in an instant messaging application, a virtual image of the user in an SNS (Social Networking Service) application, etc. In exemplary embodiments of the invention, the client terminal may include terminal devices, such as PCs (Personal Computers), tablet computers, mobile phones, smart mobile phones, laptop computers, etc. The client terminal may also include client terminal modules in the terminal devices, such as web browser client applications, instant messaging client applications, etc.

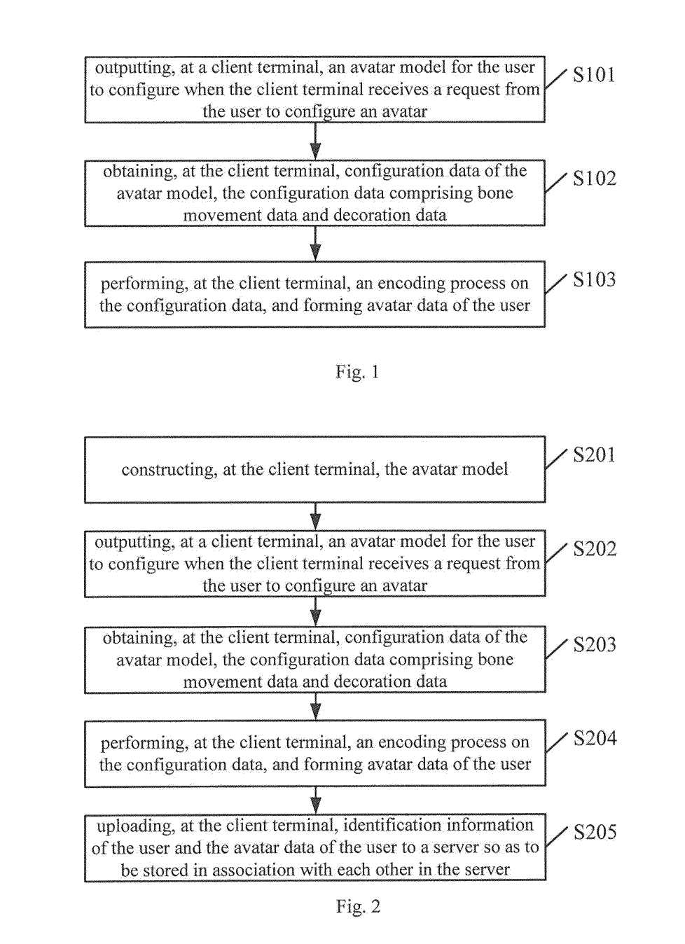

Referring to FIG. 1, it is a flow chart of a method for avatar configuration according to one embodiment of the invention. In the method, it is illustrated a flow of configuring an avatar from the client terminal side. The method may include the following steps S101-S103.

Step S101 is: outputting, at a client terminal, an avatar model for the user to configure when the client terminal receives a request from the user to configure an avatar.

In this step, the client terminal may provide an entrance for the configuration of the avatar. The entrance for the configuration may be a website. By visiting the website, the user can enter a configuration page of the avatar to configure the avatar. The entrance for configuration may also be a shortcut embedded in the client terminal, for example, a shortcut embedded in a chatting window of an instant messaging application. By clicking the shortcut, the user can enter the configuration page of the avatar to configure the avatar. In the embodiment, the configuration page of the avatar may provide a plurality of avatar models, which includes human being avatar models, animal avatar models, plant avatar models, etc. Human being avatar models may be further classified into male avatar models and female avatar models. Preferably, exemplary embodiments of the invention below would be illustrated by taking human being avatar models as examples unless otherwise stated. In this step, the user may at will select an avatar model, on the basis of which the user can configure an avatar that he/she wants. Here, to configure an avatar is substantially to define some particular things for the avatar, for example, the posture of the avatar, some decorations of the avatar, etc. The client terminal may output the avatar model requested by the user in the configuration page to provide to the user to configure an avatar through real-time interaction.

Step S102 is: obtaining, at the client terminal, configuration data of the avatar model, the configuration data comprising bone movement data and decoration data.

Wherein, the bone movement data are used to reflect the posture and/or the movements of the avatar model, for example: raising a hand, shaking the head, raising a leg, etc. The decoration data are used to reflect information of the decorations presented in the avatar model, for example, background decoration information, hair decoration information, clothing decoration information, etc.

Step S103 is: performing, at the client terminal, an encoding process on the configuration data, and forming avatar data of the user.

Wherein, the avatar data are used to reflect the avatar of the user. The process that the client terminal performs an encoding process on the configuration data may be understood as a process of integrating and encoding all configuration data. Here, integrating all configuration data means combining the configuration data together to form a particular form of data. The encoded avatar data of the user are data in a fixed coding format. The avatar data may include the configuration data and the control data for implementing the configuration data. For example, if the configuration data is data of “raising a hand,” the avatar data may include the data of “raising a hand” and control data for implementing said “raising a hand,” such as relationships between respective layers of arm bones, coordinates of bone points, rotation angles of bones, etc.

In the embodiment, the client terminal may output an avatar model for a user to configure, obtain configuration data including bone movement data and decoration data, and performing an encoding process on the configuration data to form avatar data of the user. Since the configuration data is generated by being configured by the user, and since bone movements and customized decorations may be added during the configuration, the way of configuring the avatar can be extended, and the avatar can be customized. Thus, the representation of the avatar can meet actual requirements of the user and exactly represent the image that the user wants to show.

Referring to FIG. 2, it is a flow chart of a method for avatar configuration according to another embodiment of the invention. In the method, it is illustrated a flow of configuring an avatar from the client terminal side. The method may include the following steps S201-S205.

Step S201 is: constructing, at the client terminal, the avatar model.

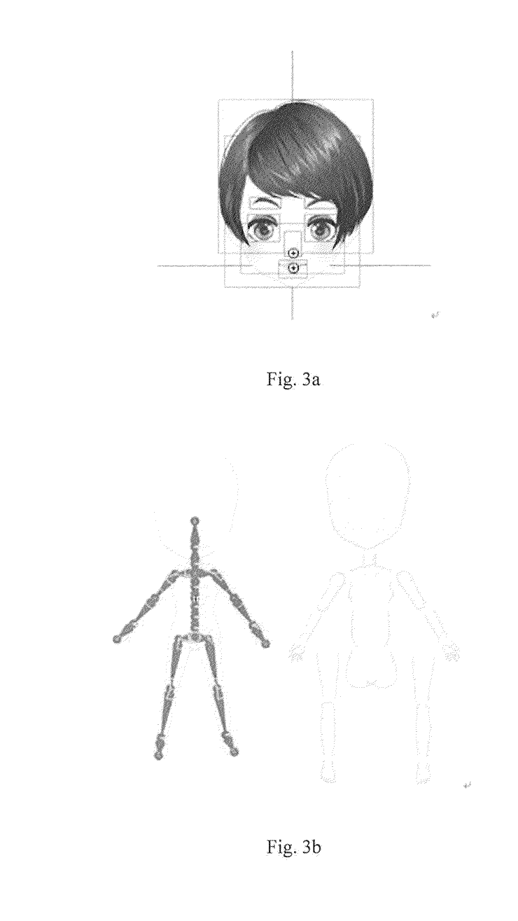

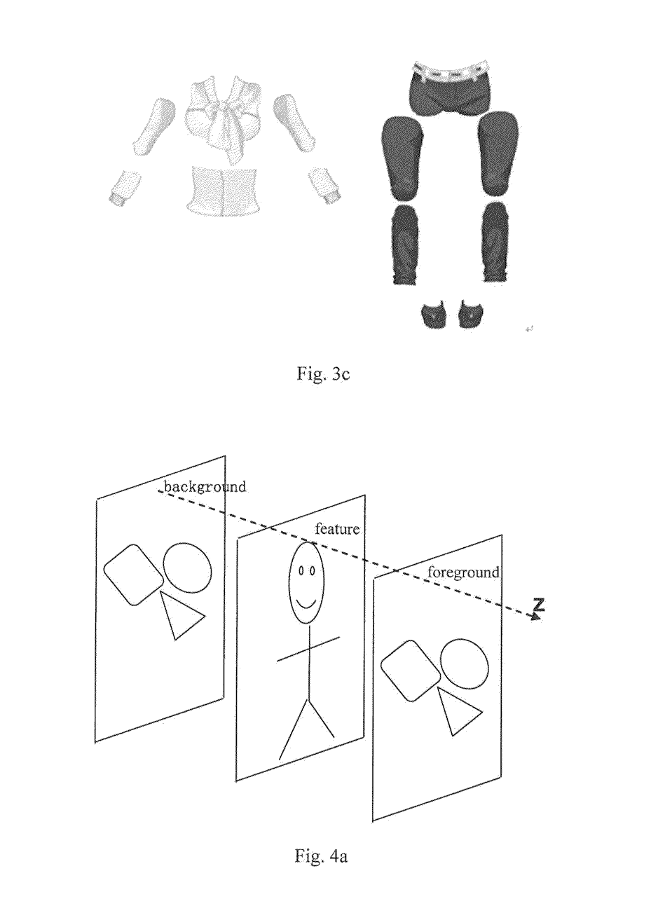

The avatar model may include a human being avatar model, an animal avatar model, a plant avatar model, etc. The avatar model may consist of a face model, a body model, and a clothing model. This embodiment is illustrated taking a human being avatar model as an example. For other kinds of avatar models, such as animal avatar models and plant avatar models, similar analysis can be made based on the description of the human being avatar model in this embodiment.

Wherein, the face model may include a plurality of facial component elements, which may include an eyebrow, an eye, a mouth, hair, etc. Please also refer to FIG. 3a, which is a structure diagram of a face model according to yet another embodiment of the invention. Particularly, FIG. 3a shows a structure diagram of a face model of a female avatar model. As shown in FIG. 3a, when constructing the face model, the whole face is divided into a plurality of facial component elements, which may include back hair, a face shape (including ears), a left eyebrow, a right eyebrow, a left eye, a right eye, a nose, a mouth, a face decoration (including cheek color, etc), a eye decoration (including false eyelashes, etc), etc. The coordinate origins of the facial component elements may be uniformly set as the center of the mouth, so that it can be guaranteed that the respective facial component elements will have right positions during the configuration process of the user.

Wherein, the body model may include a skeleton, which may include data of a plurality of bones and data of a plurality of virtual bone joints. Please also refer to FIG. 3b, which is a structure diagram of a body model according to yet another embodiment of the invention. Particularly, FIG. 3b shows a structure diagram of a face model of a female avatar model. As shown in FIG. 3b, when constructing the body model, the whole body of the figure is divided into 17 parts (please refer to the right part of FIG. 3b), and 25 bone points are added, so as to form a complete skeleton. In order to enhance the realism and stability of bone movements, 4 virtual bone joints are set respectively in the backbone portion, so that the back bone is more elastic and able to represent more flexible postures and movements (please refer to the left part of FIG. 3b). In addition, in order to restrict the freeness of movements to prevent abnormal postures or movements, in the embodiment, the client terminal may further define ranges of allowed rotation angles of each virtual bone joints, so as to prevent the avatar model from representing postures that do not comply with ergonomics.

Wherein, the clothing model comprises a plurality of clothing slices. Please also refer to FIG. 3c, which is a structure diagram of a clothing model according to yet another embodiment of the invention. Particularly, FIG. 3c shows a structure diagram of a clothing model of a female avatar model. As shown in FIG. 3c, when constructing the clothing model, the clothing material is divided correspondingly to the divided portions of the body of the avatar, and the coordinate origin of a clothing slice and that of the corresponding portion of the body should be consistent, so that it can be guaranteed that the clothing model and the body model fit with each other and the clothing model covers the body model. Specifically, please refer to the left portion of FIG. 3c, a blouse may include two left sleeve slices, two right sleeves slices, a breast clothing slice, and a waist clothing slice. Please refer to the right portion of FIG. 3c, a pair of trousers may include a buttock clothing slice, two left leg clothing slices, and two right leg clothing slices, and a pair of shoes may include a left shoe slice and a right shoe slice.

Step S202 is: outputting, at a client terminal, an avatar model for the user to configure when the client terminal receives a request from the user to configure an avatar.

Step S203 is: obtaining, at the client terminal, configuration data of the avatar model, the configuration data comprising bone movement data and decoration data.

Step S204 is: performing, at the client terminal, an encoding process on the configuration data, and forming avatar data of the user.

In the embodiment, for steps S202-S204, one may refer to steps S101-S103 shown in FIG. 1, which will not be described here to avoid redundancy.

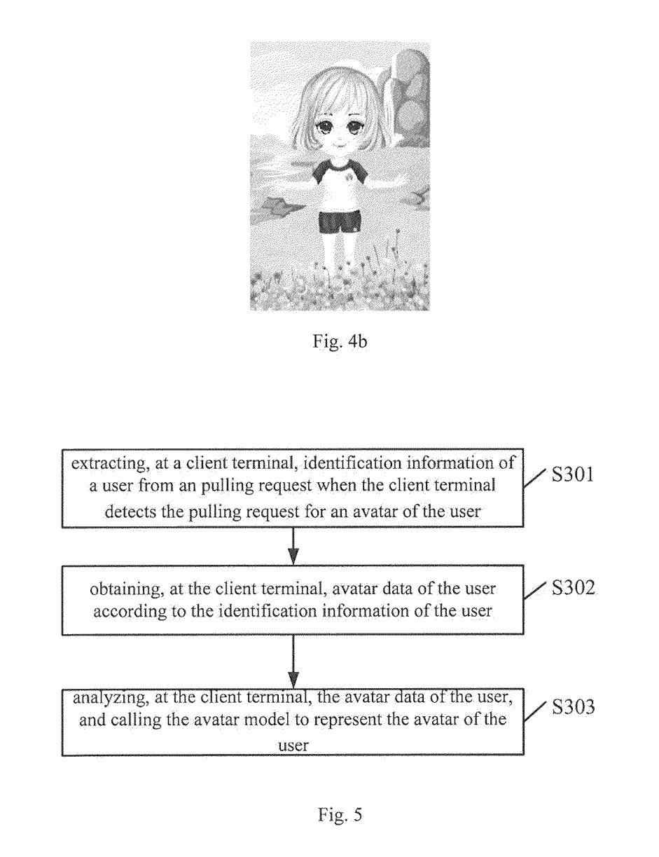

It should be made clear that the virtual image that shown by the avatar may have certain arrangement layers. Please also refer to FIG. 4a, which is a structure diagram of arrangement layers of an avatar according to yet another embodiment of the invention. As shown in FIG. 4a, an avatar may be divided into three layers including a background layer, a figure layer, and a foreground layer. The background layer is used to show background decorations that are configured by the user for the avatar model; the foreground layer is used to show foreground decorations that are configured by the user for the avatar model; and the figure layer is used to show the bone movements, clothing decorations, and facial decorations that are configured by the user for the avatar model. Please also refer to FIG. 4b, which is an effect diagram of an avatar according to yet another embodiment of the invention. Since the avatar data of the user is used to represent the avatar of the user, the avatar in the embodiment may be that shown in FIG. 4b. Correspondingly to the arrangement layers shown in FIG. 4a, in the avatar shown in FIG. 4b, the background layer shows a decoration of a landscape painting; the figure layer shows the bone movement, the clothing decoration, and the facial decoration of the girl; and the foreground layer shows a decoration of flowers.

Furthermore, it should be made clear that, with reference to the diagram shown in FIG. 4, data of an avatar should at least include contents in the following four aspects: avatar overall information, background and foreground information, figure information, and face information. In the embodiment, the client terminal may encode the configuration data into avatar data in the following format: “B1#A.avatar overall information region #B.background and foreground information region#C.figure information region#D.face information region.”

In the above format, “B1” is adopted as a head character, and “#” is used as a delimiter between respective portions of the contents of the avatar data. In the implementation, definitions for the format are shown in the following Table 1.

TABLE 1
definitions for the format of avatar data

| | Field Name | Length in Bytes | Meaning |
|---|---|---|---|
| A. Avatar Overall | 1. chAvSex | 1 | the sex of the current avatar |
| Information Region | | | (0: male, 1: female) |
| | 2. iScale | 2 | an overall scaling rate of the avatar |
| | | | (a percentage value, horizontal |
| | | | flipped if negative) |
| | 3. iXPos | 2 | an x-coordinate of the avatar |
| | | | (accurate to one decimal) |
| | 4. iYPos | 2 | a y-coordinate of the avatar |
| | | | (accurate to one decimal) |
| | 5. iEffectID | 1 | 0: no special effects; 1: the background |
| | | | has an old photo effect; 2: the whole |
| | | | avatar has an old photo effect; 3: the |
| | | | background is blurred, 4: the whole |
| | | | avatar is blurred; 5: the background is |
| | | | color filtered; 6: the whole avatar is |
| | | | color filtered. |
| | 6. iEffectParam | 1 | an old photo effect: 0-5 represents no |
| | | | special effect, 1960s, 1950s, 1940s, |
| | | | 1930s, and 1920s, respectively; |
| | | | a color filtered effect: 0-5 represents no |
| | | | special effect, blue, red, green, yellow, |
| | | | and purple, respectively; |
| | | | a blurred effect: 0-30. |
| B. Background and | 1. iItemNo | 4 | the number of the item |
| Foreground information | 2. iType | 1 | the type of the object: 0: an ordinary |
| Region | | | object; 1: an individual text (feelings |
| | | | show); 2: a flash decoration (a special |
| | | | effect show); 3: flowers; 4: an insignia; |
| | | | 5: a continuously changing facial |
| | | | expression; 6: only seen by oneself: |
| | | | 100: special, 101: a game show; 102: a |
| | | | real face show; 103: a joint photo |
| | | | show; 104: a head portrait; 105: facial |
| | | | features. |
| | 3. iPlyNo | 2 | the number of the physical layer |
| | 4. flag bit | 1 | |
| | 4.1 bMov | | movable or not |
| | 4.2 bRot | | rotatable or not |
| | 4.3 bSelc | | selectable or not |
| | 4.4 bColor | | can be filled with color or not |
| | | | (default 0) |
| | 4.5 | | binding to and movable with the |
| | bPoseBind | | movement and the position of the leg |
| | | | or not |
| | 4.6 bScale | | scalable or not |
| | 4.7 bLayer | | the layer level (front or rear) can be |
| | | | changed or not |
| | 5. iDlyNo | 2 | displaying the number of the layer |
| | 6. iXPos | 2 | an actual x-coordinate of the object |
| | | | (accurate to one decimal) |
| | 7. iYPos | 2 | an actual y-coordinate of the object |
| | | | (accurate to one decimal) |
| | 8. iRot | 2 | an actual rotation angle of the object |
| | | | (accurate to digit) |
| | 9. iScale | 2 | an overall scaling rate of the avatar (a |
| | | | percentage value; horizontal flipped if |
| | | | negative) |
| C. Figure Information | $ | | a flag bit of the bone region |
| Region | 1. | 1 | layer relationships between bones and |
| | bArmZIndex | | arms; 4 indexes indicating the |
| | | | relationships between the layer of the |
| | | | skeleton and the layer of the upper left |
| | | | arm, lower left arm, upper right arms |
| | | | and lower left arm, respectively. |
| | 2. | 2 | an x-coordinate of a bone point |
| | iBoneXPos | | acurate to one decimal) |
| | 3. | 2 | a y-coordinate of a bone point |
| | iBoneYPos | | (accurate to one decimal) |
| | 4. | 2 | a rotation angle of a bone point |
| | iBoneAngle | | (accurate to digit) |
| | 5. | 4 | the number of a piece of clothing |
| | iClothingNo | | |
| D. Face Information | & | | a flag bit of face information region |
| Region | 1 iItemNo | 4 | an id of a facial component element |
| | 2 iLayer | 1 | enumerate the types of facial |
| | | | component elements and represent the |
| | | | layer relationships; |
| | | | the types of facial component elements |
| | | | including: hair, face, ear, eye, nose, |
| | | | mouth, cheek color, beard, earring, |
| | | | glasses, etc. |
| | 3 | | the index number of color |
| | iColorIndex | | |
| | 4 iOffsetX | 2 | an x-offset (accurate to one decimal) |
| | 5 iOffset Y | 2 | a y-offset (accurate to one decimal) |
| | 6 iScaleX | 2 | an X-scaling (accurate to digit) |
| | 7 iScaleY | 2 | a y-scaling (accurate to digit) |
| | 8 iRot | 2 | a rotation angle (accurate to digit) |

Step S205 is: uploading, at the client terminal, identification information of the user and the avatar data of the user to a server so as to be stored in association with each other in the server.

Wherein, the identification information of the user is used to identify a unique user. The identification information of the user may be an ID (Identity) of the user. For example, the identification information of the user may be an instant messaging account of the user, an SNS account of the user, etc. The identification information of the user and the avatar data of the user may be stored in association with each other by the server. Thus, with the identification information of the user, the avatar data of the user can be quickly and conveniently found.

In the embodiment, the client terminal may output an avatar model for a user to configure, obtain configuration data including bone movement data and decoration data, and performing an encoding process on the configuration data to form avatar data of the user. Since the configuration data is generated by being configured by the user, and since bone movements and customized decorations may be added during the configuration, the way of configuring the avatar can be extended, and the avatar can be customized. Thus, the representation of the avatar can meet actual requirements of the user and exactly represent the image that the user wants to show.

It should be made clear that the methods for avatar configuration shown in FIGS. 1 and 2 may be executed by a functional module (for example, an editing module) in the client terminal. For example, the client terminal may load in a page of avatar configuration an editor plug-in, such as a Flash Object plug-in. Then, the editor plug-in may execute the methods for avatar configuration shown in FIGS. 1 and 2.

Referring to FIG. 5, it is a flow chart of a method for avatar realization according to yet another embodiment of the invention. The method may comprise the following steps S301-S303.

Step S301 is: extracting, at a client terminal, identification information of a user from an pulling request when the client terminal detects the pulling request for an avatar of the user.

Wherein, the pulling request for the avatar of the user may be triggered by the user himself/herself to take a look at his/her avatar. For example, a user A may click “view my avatar” at the client terminal to trigger the pulling request for the avatar, the pulling request including identification information of the user A. The pulling request for the avatar of the user may also be triggered by other users to take a look at the avatar of the user A. For example, a user B, whose is a friend of the user A in an instant messaging application, may click “view avatar of user A” in a chatting window of the instant messaging application to trigger the pulling request for the avatar, the pulling request including identification information of the user A. In another instance, a user C, whose is a friend of the user A in an SNS application, may click “view avatar of user A” in a profile page of the user A in the SNS application to trigger the pulling request for the avatar, the pulling request including identification information of the user A. In still another instance, the user A may encode the URL (Uniform Resource Locator) of a page showing his/her avatar and his/her identification information into a two-dimensional code image, and other users may send the pulling request by using a two-dimensional code identifying tool to identify the two-dimensional code. The identification information of the user is used to identify a unique user. The identification information of the user may be an ID (Identity) of the user. For example, the identification information of the user may be an instant messaging account of the user, an SNS account of the user, etc.

Step S302 is: obtaining, at the client terminal, avatar data of the user according to the identification information of the user, wherein the avatar data is formed by encoding configuration data of an avatar model, and the configuration data comprises bone movement data and decoration data.

Wherein, the avatar data may be formed by encoding the configuration data of the avatar model, the configuration data including bone movement data and decoration data. Since the server has stored the identification information of the user and the avatar data of the user in association with each other (please refer to step S205 in the embodiment shown in FIG. 2), in this step, with the identification information of the user, the client terminal can find the avatar data of the user quickly and conveniently in the server.

Step S303 is: analyzing, at the client terminal, the avatar data of the user, and calling the avatar model to represent the avatar of the user.

Since the avatar data of the user is data in a fixed coding format, in this step, the client terminal needs to analyze the avatar data of the user according to the fixed coding format and then obtain configuration data of the avatar model and control data for implementing the configuration data. The client terminal may call the avatar model and represent the avatar model based on the analyzed configuration data and control data. Thereby, the avatar of the user can be generated.

In the embodiment, the client terminal may obtain the avatar data of the user according to the identification information of the user and represent the avatar of the user according to the avatar data. The avatar data is formed by encoding the configuration data including bone movement data and decoration data, and the configuration data is generated by being configured by the user. Moreover, bone movements and customized decorations may be added during the configuration. Thus, the representation of the avatar can meet actual requirements of the user, and the image that the user wants to show can be exactly represented.

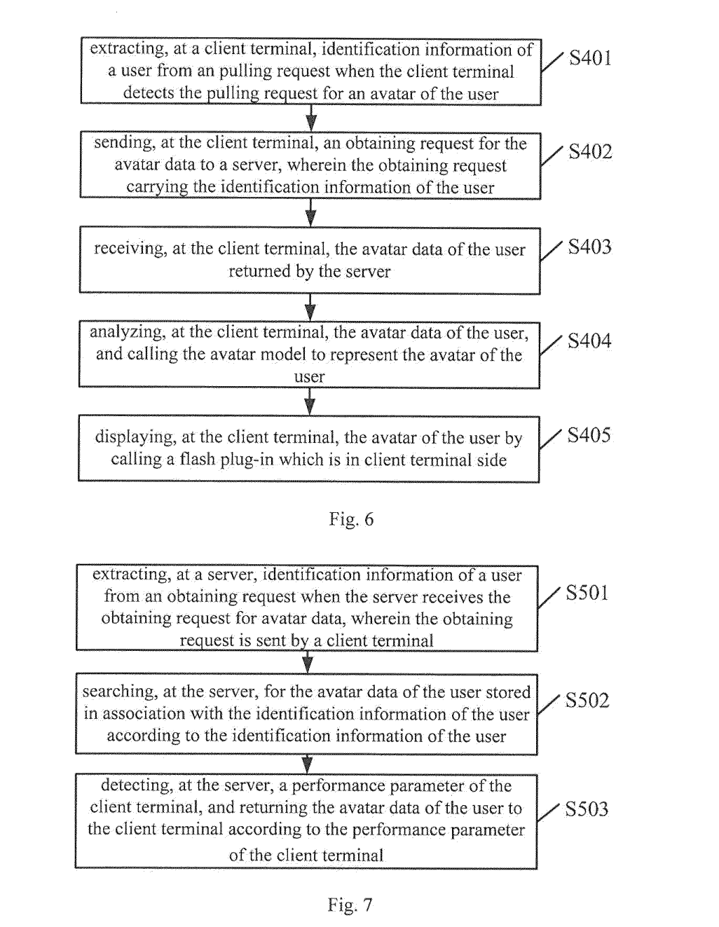

Referring to FIG. 6, it is a flow chart of a method for avatar realization according to yet another embodiment of the invention. In the method, it is illustrated a flow of realizing an avatar from the client terminal side. The method may include the following steps S401-S405.

Step S401 is: extracting, at a client terminal, identification information of a user from an pulling request when the client terminal detects the pulling request for an avatar of the user.

For step S401, one may refer to step S301 in the embodiment shown in FIG. 5, which will not be described here to avoid redundancy.

Step S402 is: sending, at the client terminal, an obtaining request for the avatar data to a server, wherein the obtaining request carrying the identification information of the user.

Wherein, the avatar data may be formed by encoding the configuration data of the avatar model, the configuration data including bone movement data and decoration data. Since the server has stored the identification information of the user and the avatar data of the user in association with each other, in this step, the client terminal may send an obtaining request for the avatar data to the server and carry the identification information of the user in the obtaining request, so as to request the server to return the avatar data of the user. After receiving the obtaining request for the avatar, according to the identification information of the user carried in the obtaining request, the server can search for the avatar data of the user which is stored in association with the identification information of the user and return it to the client terminal.

Step S403 is: receiving, at the client terminal, the avatar data of the user returned by the server.

Steps S402-S403 in the embodiment may be a specific and detailed process of step S302 in the embodiment shown in FIG. 5. By storing the identification information of the user and the avatar data of the user in association with each other, the avatar data of the user can be quickly and conveniently found with the identification information of the user. Thus, the efficiency and the convenience of data obtainment can be enhanced.

Step S404 is: analyzing, at the client terminal, the avatar data of the user, and calling the avatar model to represent the avatar of the user.

For step S404, one may refer to step S303 in the embodiment shown in FIG. 5. Specifically, the avatar data of the user is data in a fixed coding format. The fixed coding format may be: “B1#A.avatar overall information region #B.background and foreground information region#C.figure information region#D.face information region.”

In this step, the client terminal may analyze the avatar data of the user according to the fixed coding format in conjunction with the definitions for the fixed format shown in the above Table 1, and thereby obtain configuration data of the avatar model and control data for implementing the configuration data. The client terminal may call the avatar model and represent the avatar model based on the configuration data and control data obtained by analyzing. The specific process for represent the avatar model may be as follows. (1) The client terminal analyzes and obtains the avatar overall information in region A of Table 1; determines to call whether a male avatar model or a female avatar model according to the information in the region A; scales the called avatar at a ratio corresponding to the information in the region A; sets a corresponding coordinate and/or position in the stage; and performs a corresponding special-effect process on the overall avatar according to pre-set special-effect configurations. (2) The client terminal analyzes and obtains the background and foreground information in region B of Table 1; downloads decoration materials of the background and the foreground according to the information in the region B; and displays the decoration materials in corresponding layers. (3) The client terminal analyzes and obtains the figure information in region C of Table 1; recovers posture of the avatar model from coordinates of bone points of the avatar model according to the information in the region C; downloads clothing materials according to clothing decoration information; and pastes the clothing materials on corresponding portions of the skeleton of the avatar model. (4) The client terminal analyzes and obtains the face information in region D of Table 1; downloads facial decoration materials according to the information in the region D; combines the facial decoration materials to form a full face; and pastes the full face on the head skeleton of the avatar model. Through the above (1) to (4), the avatar of the user can be generated.

Step S405 is: displaying, at the client terminal, the avatar of the user by calling a flash plug-in which is in client terminal side.

Flash is a kind of fully developed technique for network multi-media. A flash plug-in has functionality of analyzing data and representing data into images or animation. In the embodiment, preferably, the client terminal may support a Flash plug-in and have had the Flash plug-in installed in it. In the embodiment, the client terminal is able to provide a representation page for the avatar of the user, and play the avatar of the user in the representation page by calling the Flash plug-in which is in the client terminal side.

In the embodiment, the client terminal may obtain the avatar data of the user according to the identification information of the user and represent the avatar of the user according to the avatar data. The avatar data is formed by encoding the configuration data including bone movement data and decoration data, and the configuration data is generated by being configured by the user. Moreover, bone movements and customized decorations may be added during the configuration. Thus, the representation of the avatar can meet actual requirements of the user, and the image that the user wants to show can be exactly represented.

It should be made clear that the methods for avatar realization shown in FIGS. 5 and 6 may be executed by a functional module (for example, a view module) in the client terminal. For example, the client terminal may load in a page of avatar configuration a viewer plug-in, such as a Flash plug-in program written in ActionScrip3.0. Then, the viewer plug-in may execute the methods for avatar realization shown in FIGS. 5 and 6. Furthermore, the client terminal may encode an address of the page showing the avatar of the user and the identification information of the user into a two-dimensional code image. For example, the client terminal may encode a URL address of the page showing the avatar of the user and the identification information of the user into a two-dimensional code image. With the two-dimensional code image, the page showing the avatar of the user can be rapidly shared. For example, a client terminal may enter the page showing the avatar of the user by scanning the two-dimensional code image so as to view the avatar of the user. By rapidly sharing the page showing the avatar of the user with the two-dimensional code image, the share interface and the share way of the avatar can be effectively extended.

Referring to FIG. 7, it is a flow chart of a method for avatar realization according to yet another embodiment of the invention. In the method, it is illustrated a flow of realizing an avatar from the server side. The method may include the following steps S501-S503.

Step S501 is: extracting, at a server, identification information of a user from an obtaining request when the server receives the obtaining request for avatar data, wherein the obtaining request is sent by a client terminal.

When the client terminal needs to request the avatar data of the user from the server, it may send the obtaining request for the avatar data to the server and carry the identification information of the user in the obtaining request. In this step, the server extracts the identification information of the user from the obtaining request. The identification information of the user is used to identify a unique user. The identification information of the user may be an ID (Identity) of the user. For example, the identification information of the user may be an instant messaging account of the user, an SNS account of the user, etc.

Step S502 is: searching, at the server, for the avatar data of the user stored in association with the identification information of the user according to the identification information of the user.

Wherein, the avatar data may be formed by encoding the configuration data of the avatar model, the configuration data including bone movement data and decoration data. Since the server has stored the identification information of the user and the avatar data of the user in association with each other, in this step, the server may search for, according to the identification information of the user, the avatar data which is stored in association with the identification information of the user.

Step S503 is: detecting, at the server, a performance parameter of the client terminal, and returning the avatar data of the user to the client terminal according to the performance parameter of the client terminal.

Wherein, the main purpose for the server to detect the performance parameter of the client terminal is to judge whether the client terminal is capable of analyzing the avatar data to represent the avatar of the user. The server may adopt an appropriate way to return the avatar data to the user according to the detected result, so as to enable the client terminal to recover the avatar of the user.

In the embodiment, the server returns the avatar data to the user according to the identification information of the user, so as to enable the client to recover and display the avatar of the user. The avatar data is formed by encoding the configuration data including bone movement data and decoration data, and the configuration data is generated by being configured by the user. Moreover, bone movements and customized decorations may be added during the configuration. Thus, the representation of the avatar can meet actual requirements of the user, and the image that the user wants to show can be exactly represented.

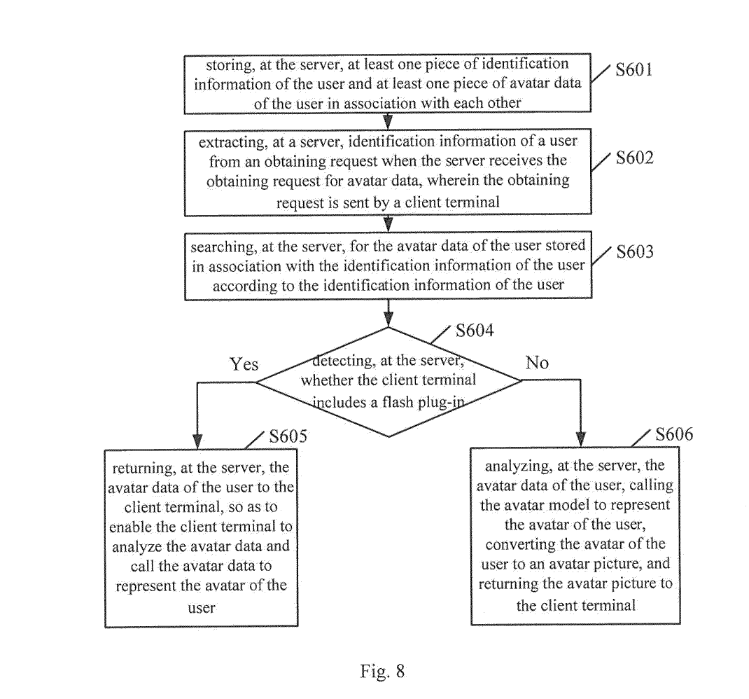

Referring to FIG. 8, it is a flow chart of a flow chart of a method for avatar realization according to yet another embodiment of the invention. In the method, it is illustrated a flow of realizing an avatar from the server side. The method may include the following steps S601-S606.

Step S601 is: storing, at the server, at least one piece of identification information of the user and at least one piece of avatar data of the user in association with each other.

Wherein, one piece of identification information of the user is associated with one piece of avatar data. The server associates the identification information of the user with the avatar data of the user and stores them. Thus, with the identification information of the user, the avatar data of the user can be found quickly and conveniently, which enhances efficiency and convenience of data obtainment.

Step S602 is: extracting, at a server, identification information of a user from an obtaining request when the server receives the obtaining request for avatar data, wherein the obtaining request is sent by a client terminal.

Step S603 is: searching, at the server, for the avatar data of the user stored in association with the identification information of the user according to the identification information of the user, wherein the avatar data is formed by encoding configuration data of an avatar model, and the configuration data comprises bone movement data and decoration data.

In the embodiment, for steps S602-S603, one may refer to steps S501-S502 shown in FIG. 7, which will not be described here to avoid redundancy.

Step S604 is: detecting, at the server, whether the client terminal includes a flash plug-in; if yes, turning to step S605; and if no, turning to step S606.

In the implementation, the client terminal may report to the server whether it has a Flash plug-in or not. For example, the information to be reported may be added into the obtaining request for the avatar data. The server may, according to the reported information carried in the obtaining request, detect whether the client terminal includes a Flash plug-in. If it is detected that the client terminal includes a Flash plug-in, the client terminal is capable of analyzing the avatar data of the user and representing the avatar of the user. So, the flow turns to step S605. If it is detected that the client terminal does not include a Flash plug-in, it is indicated that the client terminal is incapable of analyzing the avatar data of the user or representing the avatar of the user. So, the flow turns to step S606.

Step S605 is: returning, at the server, the avatar data of the user to the client terminal, so as to enable the client terminal to analyze the avatar data and call the avatar data to represent the avatar of the user. Then, the flow comes to an end.

In the step, after detecting that the client terminal includes a Flash plug-in, the server may directly return the avatar data of the server to the client terminal. This will enable the client terminal to analyze the avatar data and call the avatar model to represent the avatar of the user. For the process of analyzing and representing the avatar at the client terminal, one may refer to relevant descriptions of the embodiments shown in FIGS. 5 and 6, which will not be described here to avoid redundancy.

Step S606 is: analyzing, at the server, the avatar data of the user, calling the avatar model to represent the avatar of the user, converting the avatar of the user to an avatar picture, and returning the avatar picture to the client terminal. Then, the flow comes to an end.

In the step, after detecting that the client terminal does not include a Flash plug-in, the server may analyze the avatar data of the user, call the avatar model to represent the avatar of the user, convert the represented avatar of the user into an avatar picture, and return the picture to the client terminal. This will enable the client terminal to directly display the avatar picture so as to show the avatar of the user. Wherein, the server may also generate the avatar picture of the user by calling a Flash plug-in. For the process of analyzing and representing the avatar at the server, one may refer to the descriptions of analyzing and representing the avatar at the client terminal in the embodiments shown in FIGS. 5 and 6, which will not be described here to avoid redundancy.

In the embodiment, the server returns the avatar data to the user according to the identification information of the user, so as to enable the client to recover and display the avatar of the user. The avatar data is formed by encoding the configuration data including bone movement data and decoration data, and the configuration data is generated by being configured by the user. Moreover, bone movements and customized decorations may be added during the configuration. Thus, the representation of the avatar can meet actual requirements of the user, and the image that the user wants to show can be exactly represented.

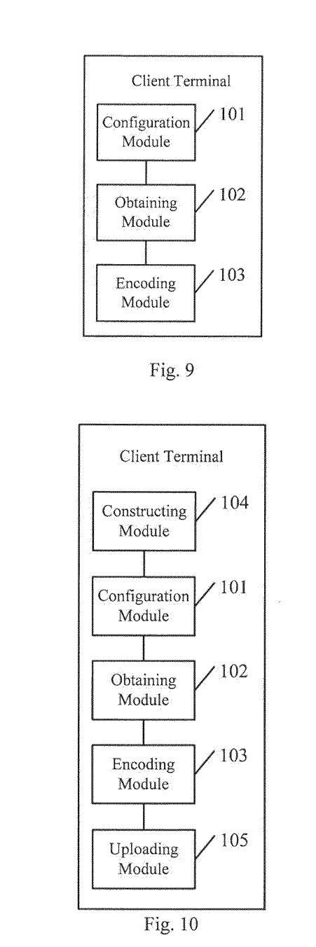

Below, structures of some client terminals will be described in detail in conjunction with FIGS. 9 and 10. It should be made clear that the client terminals shown in FIGS. 9 and 10 are configured to implement the methods in the embodiments shown in FIGS. 1 and 2. For convenience of description, only those relevant to the embodiments are described here, and for specific details that are not described, one may refer to the embodiments shown in FIGS. 1 and 2.

Referring to FIG. 9, it is a structure diagram of a client terminal according to yet another embodiment of the invention. The client terminal may include a configuration module 101, an obtaining module 102, and an encoding module 103.

The configuration module 101 is configured to output an avatar model for the user to configure when receiving a request from the user to configure an avatar.

The client terminal may provide an entrance for the configuration of the avatar. The entrance for the configuration may be a website. By visiting the website, the user can enter the configuration page of the avatar to configure the avatar. The entrance for configuration may also be a shortcut embedded in the client terminal, for example, a shortcut embedded in a chatting window of an instant messaging application. By clicking the shortcut, the user can enter the configuration page of the avatar to configure the avatar. In the embodiment, the configuration page of the avatar may provide a plurality of avatar models, which includes human being avatar models, animal avatar models, plant avatar models, etc. Human being avatar models may be further classified into male avatar models and female avatar models. Preferably, exemplary embodiments of the invention below would be illustrated by taking human being avatar models as examples unless otherwise stated. The user may at will select an avatar model. The configuration module 101 may output the avatar model requested by the user in the configuration page to provide to the user to configure an avatar through real-time interaction, so as to generate the avatar that the user wants.

The obtaining module 102 is configured to obtain configuration data of the avatar model, the configuration data comprising bone movement data and decoration data.

Wherein, the bone movement data are used to reflect the posture and/or the movements of the avatar model, for example: raising a hand, shaking the head, raising a leg, etc. The decoration data are used to reflect information of the decorations presented in the avatar model, for example, background decoration information, hair decoration information, clothing decoration information, etc.

The encoding module 103 is configured to perform an encoding process on the configuration data, and form avatar data of the user.

Wherein, the avatar data are used to reflect the avatar of the user. The process that the encoding processing module 103 performs an encoding process on the configuration data may be understood as a process of integrating and encoding all configuration data. The encoded avatar data of the user are data in a fixed coding format. The avatar data may include the configuration data and the control data for implementing the configuration data. For example, if the configuration data is data of “raising a hand,” the avatar data may include the data of “raising a hand” and control data for implementing said “raising a hand,” such as relationships between respective layers of arm bones, coordinates of bone points, rotation angles of bones, etc. In the implementation, for definitions for the fixed format, one may refer to the above Table 1.

In the embodiment, the client terminal may output an avatar model for a user to configure, obtain configuration data including bone movement data and decoration data, and performing an encoding process on the configuration data to form avatar data of the user. Since the configuration data is generated by being configured by the user, and since bone movements and customized decorations may be added during the configuration, the way of configuring the avatar can be extended, and the avatar can be customized. Thus, the representation of the avatar can meet actual requirements of the user and exactly represent the image that the user wants to show.

Referring to FIG. 10, it is a structure diagram of a client terminal according to yet another embodiment of the invention. The client terminal may include a configuration module 101, an obtaining module 102, an encoding module 103, a constructing module 104, and an uploading module 105. For the structures of the configuration module 101, the obtaining module 102, and the encoding module 103, one may refer to relevant descriptions in the embodiment shown in FIG. 9, which will not be described here to avoid redundancy.

The constructing module 104 is configured to construct at least one avatar model.

The avatar model may include a human being avatar model, an animal avatar model, a plant avatar model, etc. The avatar model may consist of a face model, a body model, and a clothing model. This embodiment is illustrated taking a human being avatar model as an example. For other kinds of avatar models, such as animal avatar models and plant avatar models, similar analysis can be made based on the description of the human being avatar model in this embodiment. For the face model, one may refer to the structure shown in FIG. 3a, the face model including a plurality of facial component elements. For the body model, one may refer to the structure shown in FIG. 3b, the body model including a skeleton, which may include data of a plurality of bones and data of a plurality of virtual bone joints. For the clothing model, one may refer to the structure shown in FIG. 3c, the clothing model including a plurality of clothing slices.

The uploading module 105 is configure to upload identification information of the user and the avatar data of the user to a server so as to store the identification information of the user and the avatar data of the user in association with each other in the server.

Wherein, the identification information of the user is used to identify a unique user. The identification information of the user may be an ID of the user. For example, the identification information of the user may be an instant messaging account of the user; an SNS account of the user, etc. The storing module 105 may upload the identification information of the user and the avatar data of the user to the server. The server may store the identification information of the user and the avatar data of the user in association with each other. Thus, with the identification information of the user, the avatar data of the user can be quickly and conveniently found, and efficiency and convenience of obtaining data is enhanced.

In the embodiment, the client terminal may output an avatar model for a user to configure, obtain configuration data including bone movement data and decoration data, and performing an encoding process on the configuration data to form avatar data of the user. Since the configuration data is generated by being configured by the user, and since bone movements and customized decorations may be added during the configuration, the way of configuring the avatar can be extended, and the avatar can be customized. Thus, the representation of the avatar can meet actual requirements of the user and exactly represent the image that the user wants to show.

It should be made clear that the structures and the functionalities of the client terminals shown in FIGS. 9 and 10 may be realized with the methods in the embodiments shown in FIGS. 1 and 2. For the specific realization flows, one may refer to relevant descriptions in the embodiments shown in FIGS. 1 and 2, which will not be described here to avoid redundancy.

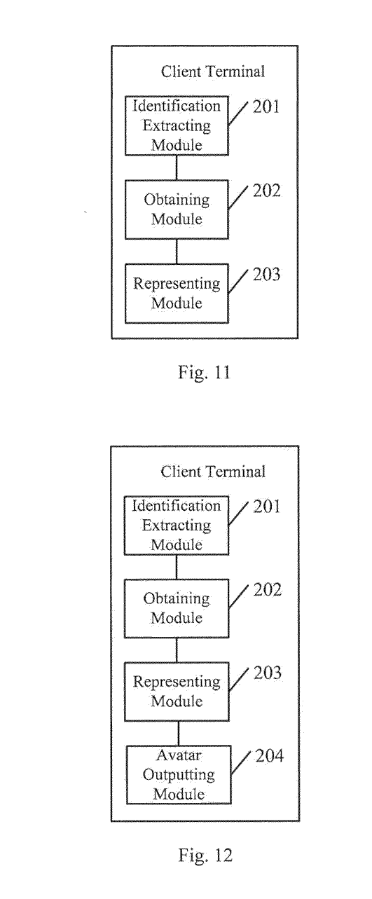

Below, structures of some other client terminals will be described in detail in conjunction with FIGS. 11-13. It should be made clear that the client terminals shown in FIGS. 11-13 are configured to implement the methods in the embodiments shown in FIGS. 5 and 6. For convenience of description, only those relevant to the embodiments are described here, and for specific details that are not described, one may refer to the embodiments shown in FIGS. 5 and 6.

Referring to FIG. 11, it is a structure diagram of a client terminal according to yet another embodiment of the invention. The client terminal may include an identification extracting module 201, an obtaining module 202, and a representing module 203.

The identification extracting module 201 is configured to extract identification information of a user from an pulling request when detecting the pulling request for an avatar of the user.

Wherein, the pulling request for the avatar of the user may be triggered by the user himself/herself to take a look at his/her avatar. For example, a user A may click “view my avatar” at the client terminal to trigger the pulling request for the avatar, the pulling request including identification information of the user A. The pulling request for the avatar of the user may also be triggered by other users to take a look at the avatar of the user A. For example, a user B, whose is a friend of the user A in an instant messaging application, may click “view avatar of user A” in a chatting window of the instant messaging application to trigger the pulling request for the avatar, the pulling request including identification information of the user A. In another instance, a user C, whose is a friend of the user A in an SNS application, may click “view avatar of user A” in a profile page of the user A in the SNS application to trigger the pulling request for the avatar, the pulling request including identification information of the user A. In still another instance, the user A may encode the URL of a page showing his/her avatar and his/her identification information into a two-dimensional code image, and other users may send the pulling request by using a two-dimensional code identifying tool to identify the two-dimensional code. The identification information of the user, which is extracted by the identification extraction module 201, is used to identify a unique user. The identification information of the user may be an ID (Identity) of the user. For example, the identification information of the user may be an instant messaging account of the user, an SNS account of the user, etc.

The obtaining module 202 is configured to obtain avatar data of the user according to the identification information of the user.

Wherein, the avatar data may be formed by encoding the configuration data of the avatar model, the configuration data including bone movement data and decoration data. Since the server has stored the identification information of the user and the avatar data of the user in association with each other, with the identification information of the user, the obtaining module 202 can find the avatar data of the user quickly and conveniently in the server.

The representing module 203 is configured to analyze the avatar data of the user and call the avatar model to represent the avatar of the user.

Since the avatar data of the user is data in a fixed coding format, the representing module 203 needs to analyze the avatar data of the user according to the fixed coding format and then obtain configuration data of the avatar model and control data for implementing the configuration data. The representing module 203 may call the avatar model and represent the avatar model based on the analyzed configuration data and control data. Thereby, the avatar of the user can be generated.

In the implementation, the representing module 203 may analyze the avatar data of the user according to the fixed coding format in conjunction with the definitions for the fixed format shown in the above Table 1, and thereby obtain configuration data of the avatar model and control data for implementing the configuration data. The representing module 203 may call the avatar model and represent the avatar model based on the configuration data and control data obtained by analyzing. The specific process for represent the avatar model may be as follows. (1) The representing module 203 analyzes and obtains the avatar overall information in region A of Table 1; determines to call whether a male avatar model or a female avatar model according to the information in the region A; scales the called avatar at a ratio corresponding to the information in the region A; sets a corresponding coordinate and/or position in the stage; and performs a corresponding special-effect process on the overall avatar according to pre-set special-effect configurations. (2) The representing module 203 analyzes and obtains the background and foreground information in region B of Table 1; downloads decoration materials of the background and the foreground according to the information in the region B; and displays the decoration materials in corresponding layers. (3) The representing module 203 analyzes and obtains the figure information in region C of Table 1; recovers posture of the avatar model from coordinates of bone points of the avatar model according to the information in the region C; downloads clothing materials according to clothing decoration information; and pastes the clothing materials on corresponding portions of the skeleton of the avatar model. (4) The representing module 203 analyzes and obtains the face information in region D of Table 1; downloads facial decoration materials according to the information in the region D; combines the facial decoration materials to form a full face; and pastes the full face on the head skeleton of the avatar model. Through the above (1)-(4), the avatar of the user can be generated.

In the embodiment, the client terminal may obtain the avatar data of the user according to the identification information of the user and represent the avatar of the user according to the avatar data. The avatar data is formed by encoding the configuration data including bone movement data and decoration data, and the configuration data is generated by being configured by the user. Moreover, bone movements and customized decorations may be added during the configuration. Thus, the representation of the avatar can meet actual requirements of the user, and the image that the user wants to show can be exactly represented.

Referring to FIG. 12, it is a structure diagram of a client terminal according to yet another embodiment of the invention. The client terminal may include an identification extracting module 201, an obtaining module 202, a representing module 203, and an avatar outputting module 204. For the structures of the identification extracting module 201, the obtaining module 202, and the representing module 203, one may refer to relevant descriptions in the embodiment shown in FIG. 11, which will not be described here to avoid redundancy.

The avatar outputting module 204 is configured to display the avatar of the user by calling a flash plug-in which is in client terminal side.

Flash is a kind of fully developed technique for network multi-media. A flash plug-in has functionality of analyzing data and representing data into images or animation. In the embodiment, preferably, the client terminal may support a Flash plug-in and have had the Flash plug-in installed in it. In the embodiment, the client terminal is able to provide a representation page for the avatar of the user, and avatar outputting module 204 is configured to display the avatar of the user in the representation page by calling the Flash plug-in which is in the client terminal side.

In the embodiment, the client terminal may obtain the avatar data of the user according to the identification information of the user and represent the avatar of the user according to the avatar data. The avatar data is formed by encoding the configuration data including bone movement data and decoration data, and the configuration data is generated by being configured by the user. Moreover, bone movements and customized decorations may be added during the configuration. Thus, the representation of the avatar can meet actual requirements of the user, and the image that the user wants to show can be exactly represented.

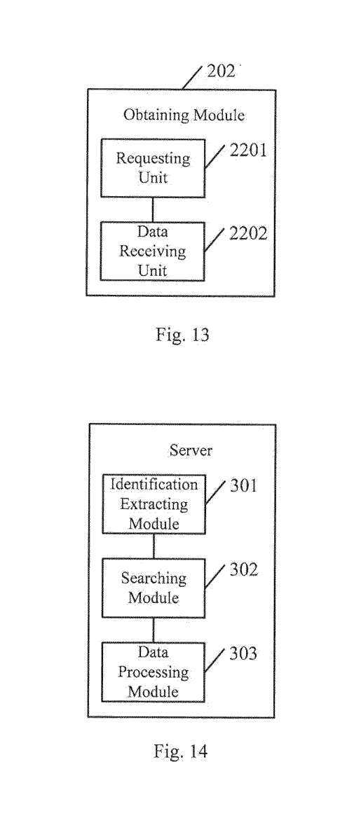

Referring to FIG. 13, it is a structure diagram of a client terminal according to yet another embodiment of the invention. The obtaining module 202 may include a requesting unit 2201 and a data receiving unit 2202.

The requesting unit 2201 is configured to send an obtaining request for the avatar data to a server, wherein the obtaining request carrying the identification information of the user, so as to enable the server to search for the avatar data stored in association with the identification information of the user.

Since the server has stored the identification information of the user and the avatar data of the user in association with each other, the requesting unit 2201 may send an obtaining request for the avatar data to the server and carry the identification information of the user in the obtaining request, so as to request the server to return the avatar data of the user. After receiving the obtaining request for the avatar, according to the identification information of the user carried in the obtaining request, the server can search for the avatar data of the user which is stored in association with the identification information of the user.

The data receiving unit 2202 is configured to receive the avatar data of the user returned by the server.

In the embodiment, the client terminal may obtain the avatar data of the user according to the identification information of the user and represent the avatar of the user according to the avatar data. The avatar data is formed by encoding the configuration data including bone movement data and decoration data, and the configuration data is generated by being configured by the user. Moreover, bone movements and customized decorations may be added during the configuration. Thus, the representation of the avatar can meet actual requirements of the user, and the image that the user wants to show can be exactly represented.

It should be made clear that the structures and the functionalities of the client terminals shown in FIGS. 11-13 may be realized with the methods in the embodiments shown in FIGS. 5 and 6. For the specific realization flows, one may refer to relevant descriptions in the embodiments shown in FIGS. 5 and 6, which will not be described here to avoid redundancy.

Below, structures of some servers will be described in detail in conjunction with FIGS. 14-16. It should be made clear that the servers shown in FIGS. 14-16 are configured to implement the methods in the embodiments shown in FIGS. 7 and 8. For convenience of description, only those relevant to the embodiments are described here, and for specific details that are not described, one may refer to the embodiments shown in FIGS. 7 and 8.

Referring to FIG. 14, it is a structure diagram of a server according to yet another embodiment of the invention. The server may include an identification extracting module 301, a searching module 302, and a data processing module 303.

The identification extracting module 301 is configured to extract identification information of a user from an obtaining request when receiving the obtaining request for avatar data.

When the client terminal needs to request the avatar data of the user from the server, it may send the obtaining request for the avatar data to the server and carry the identification information of the user in the obtaining request. The identification extraction module 301 extracts the identification information of the user from the obtaining request. The identification information of the user is used to identify a unique user. The identification information of the user may be an ID (Identity) of the user. For example, the identification information of the user may be an instant messaging account of the user, an SNS account of the user, etc.

The searching module 302 is configured to search for the avatar data of the user stored in association with the identification information of the user according to the identification information of the user.

Wherein, the avatar data may be formed by encoding the configuration data of the avatar model, the configuration data including bone movement data and decoration data. Since the server has stored the identification information of the user and the avatar data of the user in association with each other, in this step, the server may search for, according to the identification information of the user, the avatar data which is stored in association with the identification information of the user.

The data processing module 303 is configured to detect a performance parameter of the client terminal and return the avatar data of the user to the client terminal according to the performance parameter of the client terminal.

Wherein, the main purpose for the data processing module 303 to detect the performance parameter of the client terminal is to judge whether the client terminal is capable of analyzing the avatar data to represent the avatar of the user. The data processing module 303 may adopt an appropriate way to return the avatar data to the user according to the detected result, so as to enable the client terminal to recover the avatar of the user.

In the embodiment, the server returns the avatar data to the user according to the identification information of the user, so as to enable the client to recover and display the avatar of the user. The avatar data is formed by encoding the configuration data including bone movement data and decoration data, and the configuration data is generated by being configured by the user. Moreover, bone movements and customized decorations may be added during the configuration. Thus, the representation of the avatar can meet actual requirements of the user, and the image that the user wants to show can be exactly represented.

Referring to FIG. 15, it is a structure diagram of a server according to yet another embodiment of the invention. The server may include an identification extracting module 301, a searching module 302, a data processing module 303, and a storing module 304. For the structures of the identification extracting module 301, the searching module 302, and the data processing module 303, one may refer to relevant descriptions in the embodiment shown in FIG. 14, which will not be described here to avoid redundancy.

The storing module 304 is configured to store at least one piece of identification information of the user and at least one piece of avatar data of the user in association with each other, wherein one piece of identification information of the user is associated one piece of avatar data of the user.

Wherein, one piece of identification information of the user is associated with one piece of avatar data. The storing module 304 associates the identification information of the user with the avatar data of the user and stores them. Thus, with the identification information of the user, the avatar data of the user can be found quickly and conveniently, which enhances efficiency and convenience of data obtainment.

In the embodiment, the server returns the avatar data to the user according to the identification information of the user, so as to enable the client to recover and display the avatar of the user. The avatar data is formed by encoding the configuration data including bone movement data and decoration data, and the configuration data is generated by being configured by the user. Moreover, bone movements and customized decorations may be added during the configuration. Thus, the representation of the avatar can meet actual requirements of the user, and the image that the user wants to show can be exactly represented.

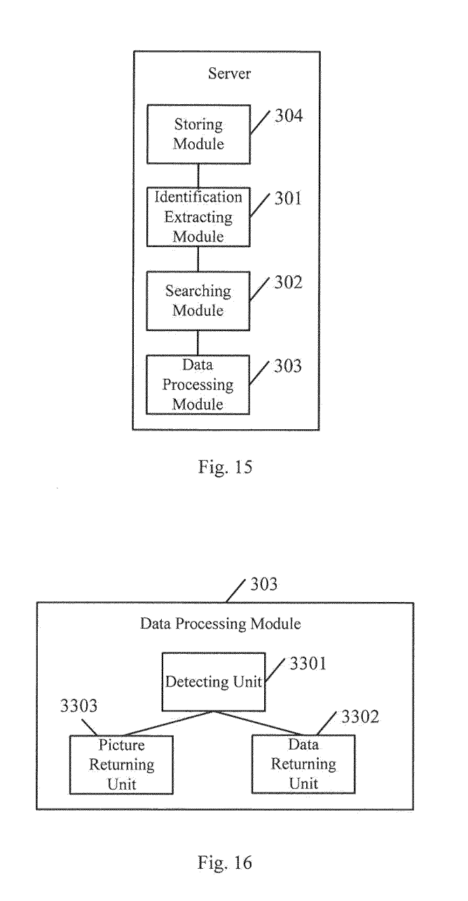

Referring to FIG. 16, it is a structure diagram of a data processing module of a server according to yet another embodiment of the invention. The data processing module 303 may include a detecting module 3301, a data returning unit 3302, and a picture returning unit 3303.

The detecting unit 3301 is configured to detect whether the client terminal includes a flash plug-in.

In the implementation, the client terminal may report to the server whether it has a Flash plug-in or not. For example, the information to be reported may be added into the obtaining request for the avatar data. The detecting unit 3301 may, according to the reported information carried in the obtaining request, detect whether the client terminal includes a Flash plug-in. If it is detected that the client terminal includes a Flash plug-in, the client terminal is capable of analyzing the avatar data of the user and representing the avatar of the user. If it is detected that the client terminal does not include a Flash plug-in, it is indicated that the client terminal is incapable of analyzing the avatar data of the user or representing the avatar of the user.

The data returning unit 3302 is configured to, if the client terminal includes the flash plug-in, return the avatar data of the user to the client terminal, so as to enable the client terminal to analyze the avatar data and call the avatar data to represent the avatar of the user.

The picture returning unit 3303 is configured to, if the client terminal does not include the flash plug-in, analyze the avatar data of the user, call the avatar model to represent the avatar of the user, convert the avatar of the user to an avatar picture, and return the avatar picture to the client terminal.

In the embodiment, the server returns the avatar data to the user according to the identification information of the user, so as to enable the client to recover and display the avatar of the user. The avatar data is formed by encoding the configuration data including bone movement data and decoration data, and the configuration data is generated by being configured by the user. Moreover, bone movements and customized decorations may be added during the configuration. Thus, the representation of the avatar can meet actual requirements of the user, and the image that the user wants to show can be exactly represented.

It should be made clear that the structures and the functionalities of the servers shown in FIGS. 14-16 may be realized with the methods in the embodiments shown in FIGS. 7 and 8. For the specific realization flows, one may refer to relevant descriptions in the embodiments shown in FIGS. 7 and 8, which will not be described here to avoid redundancy.

In various embodiments of the invention, it is also provided a system for avatar management. There may be three feasible implementation ways for the systems.

In a first feasible implementation way, the system may include a server as shown in FIGS. 14-16, and at least one client terminal as shown in FIGS. 11-13. The system in this embodiment may be applied in the method shown in FIGS. 1 and 2 to complete the avatar configuration.

In a first feasible implementation way, the system may include a server as shown in FIGS. 14-16, and at least one client terminal as shown in FIGS. 14-16. The system in this embodiment may be applied in the method shown in FIGS. 5 and 8 to complete the avatar realization.

In a first feasible implementation way, the system may include a server as shown in FIGS. 14-16, a client terminal as shown in FIGS. 11-13, and a client terminal as shown in FIGS. 14-16. The system in this embodiment may be applied in the method shown in FIGS. 1-8 to complete both of the avatar configuration and the avatar realization.

Based on the descriptions of the above ways, in this embodiment of the invention, the client terminal may output an avatar model for a user to configure, obtain configuration data including bone movement data and decoration data, and perform an encoding process on the configuration data to form avatar data of the user. The client terminal may also recover and represent the avatar of the user according to the avatar data. Since the configuration data is generated by being configured by the user, and since bone movements and customized decorations may be added during the configuration, the way of configuring the avatar can be extended, and the avatar can be customized. Thus, the representation of the avatar can meet actual requirements of the user to exactly represent the image that the user wants to show.

A person having ordinary skills in the art can realize that part or whole of the processes in the methods according to the above embodiments may be implemented by a computer program instructing relevant hardware. The program may be stored in a computer readable storage medium. When executed, the program may execute processes in the above-mentioned embodiments of methods. The storage medium may be a magnetic disk, an optical disk, a Read-Only Memory (ROM), a Random Access Memory (RAM), et al.

The foregoing descriptions are merely exemplary embodiments of the present invention, but not intended to limit the protection scope of the present invention. Any variation or replacement made by persons of ordinary skills in the art without departing from the spirit of the present invention shall fall within the protection scope of the present invention. Therefore, the scope of the present invention shall be subject to be appended claims.

1. A method for avatar configuration, comprising:
outputting, at a client terminal, an avatar model for a user to configure when the client terminal receives a request from the user to configure an avatar;
obtaining, at the client terminal, configuration data of the avatar model, the configuration data comprising bone movement data and decoration data; and
performing, at the client terminal, an encoding process on the configuration data, and forming avatar data of the user.

2. The method as claimed in claim 1, before the client terminal receives the request from the user to configure the avatar, comprising:
constructing, at the client terminal, the avatar model which comprises a face model, a body model, and a clothing model, wherein:
the face model comprises a plurality of facial component elements;
the body model comprises a skeleton, the skeleton comprising data of a plurality of bones and data of a plurality of virtual bone joints; and
the clothing model comprises a plurality of clothing slices.

3. The method as claimed in claim 1, after the step of performing, at the client terminal, the encoding process on the configuration data, and forming the avatar data of the user, comprising:
uploading, at the client terminal, identification information of the user and the avatar data of the user to a server so as to be stored in association with each other in the server.

4. A method for avatar realization, comprising:
extracting, at a client terminal, identification information of a user from an pulling request when the client terminal detects the pulling request for an avatar of the user;
obtaining, at the client terminal, avatar data of the user according to the identification information of the user, wherein the avatar data is formed by encoding configuration data of an avatar model, and the configuration data comprises bone movement data and decoration data; and
analyzing, at the client terminal, the avatar data of the user, and calling the avatar model to represent the avatar of the user.

5. The method as claimed in claim 4, wherein the step of obtaining, at the client terminal, the avatar data of the user according to the identification information of the user, comprises:
sending, at the client terminal, an obtaining request for the avatar data to a server, wherein the obtaining request carrying the identification information of the user, so as to enable the server to search for the avatar data stored in association with the identification information of the user; and
receiving, at the client terminal, the avatar data of the user returned by the server.

6. The method as claimed in claim 4, after the step of analyzing, at the client terminal, the avatar data of the user, and calling the avatar model to represent the avatar of the user, further comprising:
displaying, at the client terminal, the avatar of the user by calling a flash plug-in which is in client terminal side.

7-9. (canceled)

10. A client terminal, comprising:
a configuration module configured to output an avatar model for the user to configure when receiving a request from the user to configure an avatar;
an obtaining module configured to obtain configuration data of the avatar model, the configuration data comprising bone movement data and decoration data; and
an encoding module configured to perform an encoding process on the configuration data, and form avatar data of the user.

11. The client terminal as claimed in claim 10, comprising:
a constructing module configured to construct the avatar model which comprises a face model, a body model, and a clothing model, wherein:
the face model comprises a plurality of facial component elements;
the body model comprises a skeleton, the skeleton comprising data of a plurality of bones and data of a plurality of virtual bone joints; and
the clothing model comprises a plurality of clothing slices.

12. The client terminal as claimed in claim 10, comprising:
an uploading module, which is configured to upload identification information of the user and the avatar data of the user to a server so as to store the identification information of the user and the avatar data of the user in association with each other in the server.

13. A client terminal, comprising:
an identification extracting module, which is configured to extract identification information of a user from an pulling request when detecting the pulling request for an avatar of the user;
an obtaining module, which is configured to obtain avatar data of the user according to the identification information of the user, wherein the avatar data is formed by encoding configuration data of an avatar model, and the configuration data comprises bone movement data and decoration data; and
a representing module, which is configured to analyze the avatar data of the user and call the avatar model to represent the avatar of the user.

14. The client terminal as claimed in claim 13, wherein the obtaining module comprises:
a requesting unit, which is configured to send an obtaining request for the avatar data to a server, wherein the obtaining request carrying the identification information of the user, so as to enable the server to search for the avatar data stored in association with the identification information of the user; and
a data receiving unit, which is configured to receive the avatar data of the user returned by the server.

15. The client terminal as claimed in claim 13, comprising:
an avatar outputting module, which is configured to display the avatar of the user by calling a flash plug-in which is in client terminal side.

16-19. (canceled)

20. The method as claimed in claim 2, after the step of performing, at the client terminal, the encoding process on the configuration data, and forming the avatar data of the user, comprising:
uploading, at the client terminal, identification information of the user and the avatar data of the user to a server so as to be stored in association with each other in the server.

21. The method as claimed in claim 5, after the step of analyzing, at the client terminal, the avatar data of the user, and calling the avatar model to represent the avatar of the user, further comprising:
displaying, at the client terminal, the avatar of the user by calling a flash plug-in which is in client terminal side.

22. The client terminal as claimed in claim 11, comprising:
an uploading module, which is configured to upload identification information of the user and the avatar data of the user to a server so as to store the identification information of the user and the avatar data of the user in association with each other in the server.

23. The client terminal as claimed in claim 14, comprising:
an avatar outputting module, which is configured to display the avatar of the user by calling a flash plug-in which is in client terminal side.
